(19) United States
(12) Patent Application Publication
(10) Pub. No.: US 2009/0142985 A1
(43) Pub. Date: Jun. 4, 2009

(54) METHOD FOR MANUFACTURING LIQUID CRYSTAL DEVICE

(75) Inventor: Tamotsu GOTO, Chino (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Tokyo (JP)

(21) Appl. No.: 12/262,494

(22) Filed: Oct. 31, 2008

(30) Foreign Application Priority Data
Dec. 3, 2007 (JP) 2007-312067

(51) Int. Cl. G02F 1/1339

(52) U.S. Cl. 445/25; 349/189

(57) ABSTRACT

A method for manufacturing a liquid crystal device is one for manufacturing a liquid crystal device having liquid crystal sandwiched between a pair of substrates that are bonded together with a sealing material interposed therebetween. The method includes a spacer arrangement step of arranging spacer particles for regulating a gap between the pair of substrates in a spacer arrangement region of one of the pair of substrates; a liquid crystal application step of applying, when discharging and applying the liquid crystal as droplets to an image display region of one of the pair of substrates, the liquid crystal to enclose the spacer arrangement region, thereby forming a liquid crystal non-application region that includes the spacer arrangement region and to which the liquid crystal is not applied; and a substrate bonding step of causing the pair of substrates to face each other and bonding the pair of substrates together with the sealing material interposed therebetween.

### BACKGROUND

1. Technical Field

This invention relates to a method for manufacturing a liquid crystal device.

2. Related Art

There has been known a method for manufacturing a liquid crystal display by which spacer particles can be selectively arranged in a light shielding area of a substrate for the liquid crystal display with high efficiency as well as high accuracy using an ink-jet device, and that makes it possible to obtain a liquid crystal display that provides excellent display quality without decreases in contrast and color tone due to depolarization phenomena and light leakage attributed to spacer particles.

This method for manufacturing a liquid crystal display includes the following processes.

That is, in a liquid crystal display having pixel regions arranged according to a certain pattern and light shielding regions defining the pixel regions, a spacer particle dispersion liquid substance containing spacer particles dispersed therein is discharged by the use of an ink-jet device, and a substrate on which spacer particles are arranged in areas corresponding to the light shielding regions and a substrate on which spacer particles are not arranged are caused to face each other with the spacer particles arranged in the areas corresponding to the light shielding regions and liquid crystal interposed therebetween.

In this manufacturing method, droplets of the spacer particle dispersion liquid are landed to cover a step portion formed in the area corresponding to the light shielding region on at least one substrate, so that the spacer particles are restricted to the area corresponding to the light shielding region (see, e.g., JP-A-2005-4094).

In the foregoing method for manufacturing a liquid crystal display of related art, however, the bonding strength between spherical spacer particles arranged on a substrate and the substrate is low.

Therefore, one issue with this method is that when liquid crystal is applied onto a substrate, or when one substrate having liquid crystal applied thereon and the other substrate are bonded together, spacer particles are carried away due to the flow of the liquid crystal, moving out of a predetermined arrangement area.

The movement of spacer particles out of the predetermined arrangement area may cause defective display, and may also cause uneven cell gaps.

This results in a problem of decreasing display quality of a liquid crystal device.

### SUMMARY

An advantage of the invention is to provide a method for manufacturing a liquid crystal device that prevents spacer particles from moving out of a predetermined arrangement region due to the flow of liquid crystal, enabling the display quality to be improved.

According to an aspect of the invention, a method for manufacturing a liquid crystal device is one for manufacturing a liquid crystal device having liquid crystal sandwiched between a pair of substrates that are bonded together with a sealing material interposed therebetween.

The method includes a spacer arrangement step of arranging spacer particles for regulating a gap between the pair of substrates in a spacer arrangement region of one of the pair of substrates; a liquid crystal application step of applying, when discharging and applying the liquid crystal as droplets to an image display region of one of the pair of substrates, the liquid crystal to enclose the spacer arrangement region, thereby forming a liquid crystal non-application region that includes the spacer arrangement region and to which the liquid crystal is not applied; and a substrate bonding step of causing the pair of substrates to face each other and bonding the pair of substrates together with the sealing material interposed therebetween.

Manufacturing in this way prevents the spacer particles from being in contact with the liquid crystal in the liquid crystal application step, preventing the spacer particles from moving out of the spacer arrangement region.

Also, when the liquid crystal flows due to bonding of the substrates and the like, the liquid crystal flows from the periphery of the liquid crystal non-application region toward the inside, and further flows from the periphery of the spacer arrangement region toward the inside.

Therefore, the spacer particles arranged in the spacer arrangement region are prevented from moving from the inside to the outside of the spacer arrangement region upon the flow of the liquid crystal.

In the method for manufacturing a liquid crystal device according to the aspect of the invention, the droplets may be applied uniformly around the spacer arrangement region in the liquid crystal application step.

Manufacturing in this way causes the liquid crystal to uniformly flow from the periphery of the spacer arrangement region toward the center portion of the spacer arrangement region, causing the spacer particles to gather around the center portion.

This enables the spacer particles to be prevented with more reliability from moving to the outside of the spacer arrangement region.

In the method for manufacturing a liquid crystal device according to the aspect of the invention, the spacer particles may be arranged on one of the pair of substrates in the spacer arrangement step, and the liquid crystal may be applied onto the other of the pair of substrates in the liquid crystal application step.

Manufacturing in this way enables the spacer arrangement step and the liquid crystal application step to be performed in parallel.

This allows improved productivity of the liquid crystal device.

In the method for manufacturing a liquid crystal device according to the aspect of the invention, in the spacer arrangement step, the spacer particles may be arranged on one of the pair of substrates, and, in the liquid crystal application step, the liquid crystal may be applied onto the substrate on which the spacer particles are arranged.

Manufacturing in this way enables arrangement of the spacer particles and application of the liquid crystal to be performed collectively on one substrate.

The spacer particles are arranged on the same and one substrate, and the liquid crystal is applied around the periphery of the arranged spacer particles to form the liquid crystal non-application region.

This eliminates the need for alignment between the spacer particles and the liquid crystal non-application region when one substrate and the other substrate are caused to face each other and are bonded together.

This can facilitate alignment upon bonding of both substrates.

In the method for manufacturing a liquid crystal device according to the aspect of the invention, the liquid crystal may be applied in the liquid crystal application step, and thereafter a liquid substance containing the spacer particles dispersed therein may be applied and discharged as droplets to the spacer arrangement region.

By manufacturing in this way, the spacer particles together with the liquid substance are arranged in the spacer arrangement region within the liquid crystal non-application region on the substrate.

Therefore, the spacer particles are not in contact with the liquid crystal, preventing them from being moved by the liquid crystal.

In the case where the spacer arrangement region is the liquid crystal non-application region, liquid crystal enclosing the spacer arrangement region prevents the liquid substance applied to the spacer arrangement region from moving to the outside of the spacer arrangement region.

In the method for manufacturing a liquid crystal device according to the aspect of the invention, the liquid substance may be the liquid crystal.

Manufacturing in this way enables a step of removing the liquid substance of the spacer arrangement region to be omitted.

This simplifies the manufacturing steps, enabling the productivity to be improved.

In the method for manufacturing a liquid crystal device according to the aspect of the invention, the liquid substance may have volatility that valatilizes the liquid substance applied to the liquid crystal non-application region in the spacer arrangement step and that causes the liquid crystal to flow into the liquid crystal non-application region.

Configuration in such a way causes the liquid crystal to flow into the spacer arrangement region as the liquid substance evaporates.

This enables the spacer particles to be prevented from moving to the outside of the spacer arrangement region.

### BRIEF DESCRIPTION OF THE DRAWINGS

The invention will be described with reference to the accompanying drawings, wherein like numbers reference like elements.

FIGS. 1A and 1B are overall configuration views of a liquid crystal device in a first embodiment of the invention; FIG. 1A is a plan view and FIG. 1B is a sectional view along the line H-H′ of FIG. 1A.

FIG. 2 is an equivalent circuit diagram of the liquid crystal device in the first embodiment of the invention.

FIG. 3 is a plan view of a pixel region of the liquid crystal device in the first embodiment of the invention.

FIG. 4 is a sectional view along the line A-A′ of FIG. 3.

FIGS. 5A to 5C are explanatory views for explaining a manufacturing step of the liquid crystal device in the first embodiment of the invention.

FIG. 6 is a plan view for explaining a manufacturing step of the liquid crystal device in the first embodiment of the invention.

FIGS. 7A to 7C are explanatory views for explaining a manufacturing step of the liquid crystal device in the first embodiment of the invention.

FIGS. 8A to 8C are explanatory views for explaining a manufacturing step of a liquid crystal device in a second embodiment of the invention.

FIGS. 9A to 9C are explanatory views for explaining a manufacturing step of a liquid crystal device in a third embodiment of the invention.

### DESCRIPTION OF EXEMPLARY EMBODIMENTS

Embodiments of this invention will next be described with reference to the drawings.

Note that the scales of the members in the drawings referred to herein are changed so that each of the members can be adequately recognized.

### First Embodiment

### Liquid Crystal Device

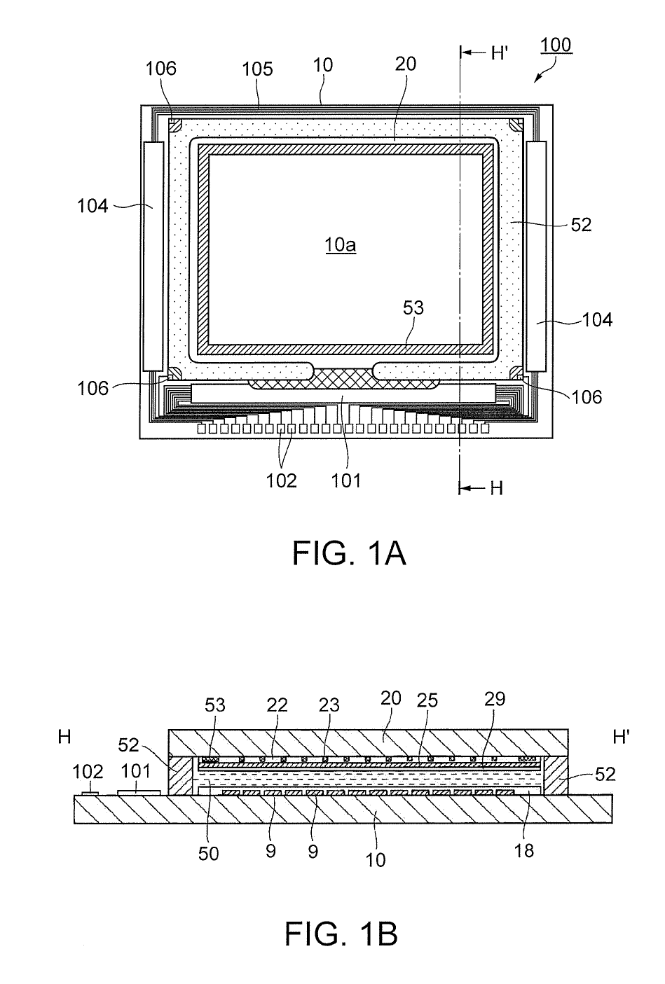

FIG. 1A is a plan view showing a liquid crystal device of the present embodiment, and FIG. 1B is a sectional view along the line H-H′ of FIG. 1A.

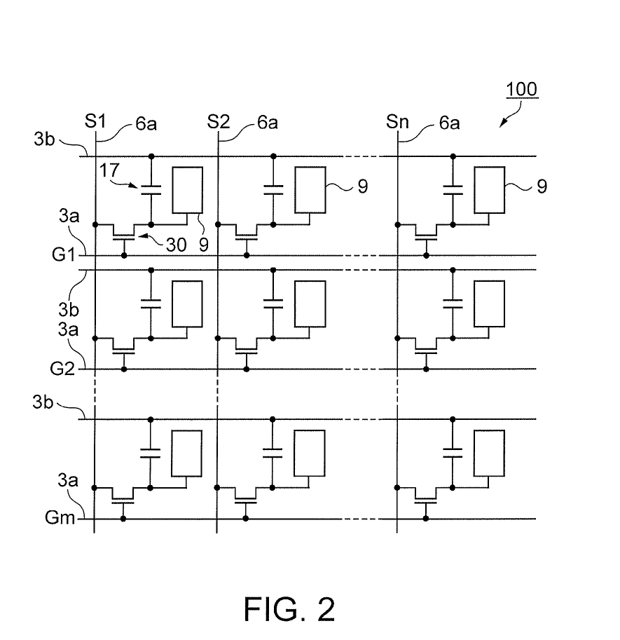

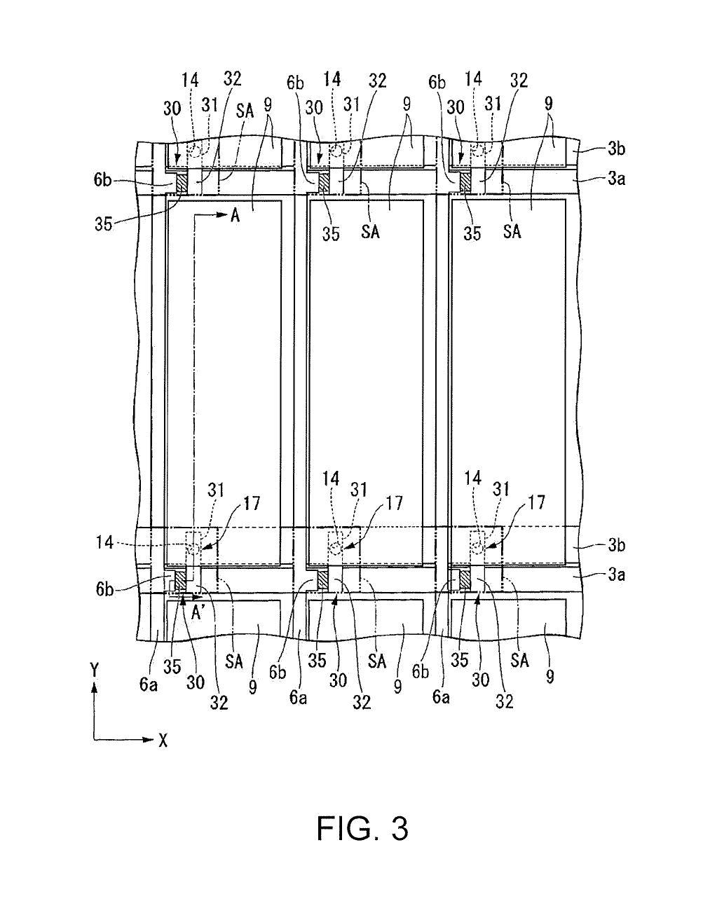

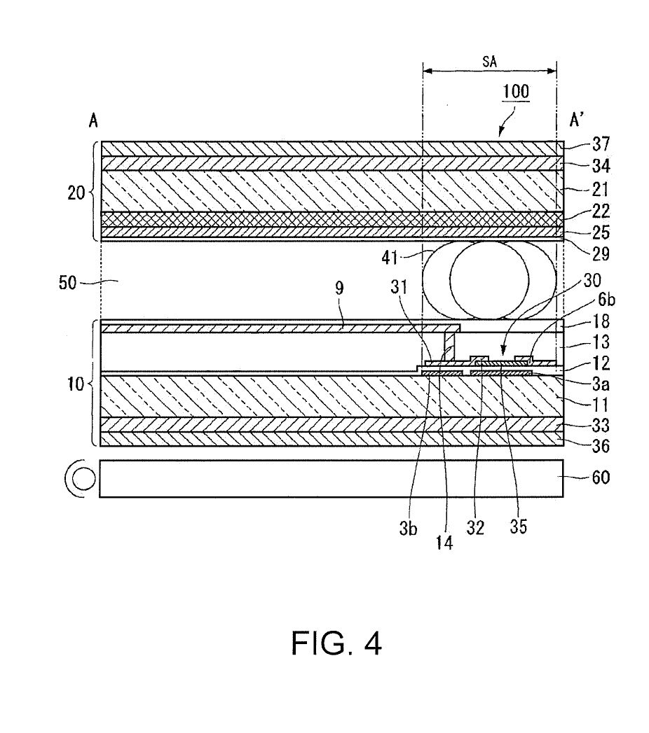

FIG. 2 is an equivalent circuit diagram showing the liquid crystal device, FIG. 3 is a plan view of the structure of pixel regions, and FIG. 4 is a sectional view of the liquid crystal device along the line A-A′ of FIG. 3.

A liquid crystal device 100 of the embodiment is an active-matrix transmission liquid crystal device, in which three subpixels outputting red (R), green (G) and blue (B) light constitute one pixel.

As used herein, a display region serving as the minimum unit constituting the display is referred to as a “subpixel region”, and a display region composed of three subpixels as a “pixel region”.

The liquid crystal device 100 includes an element substrate 10, a counter substrate 20 disposed facing the element substrate 10, and a liquid crystal layer 50 sandwiched between the element substrate 10 and the counter substrate 20, as shown in FIG. 1A and FIG. 1B.

In the liquid crystal device 100, the element substrate 10 and the counter substrate 20 are bonded together with a sealing material 52 interposed therebetween, and the liquid crystal layer 50 is sealed in an area partitioned by the sealing material 52.

A periphery partition portion 53 is formed along the internal circumference of the sealing material 52, and a rectangular area in plan view (the state of the element substrate 10 as viewed from the side of the counter substrate 20) surrounded by the periphery partition portion 53 is referred to as an “image display region 10a”.

The liquid crystal device 100 includes a data-line drive circuit 101 and scanning-line drive circuits 104 disposed in an outside area of the sealing material 52, connection terminals 102 electrically connecting the data-line drive circuit 101 to the scanning-line drive circuits 104, and interconnections 105 interconnecting the scanning-line drive circuits 104.

Arranged in the image display region 10a of the liquid crystal device 100, as shown in FIG. 2, are a plurality of subpixel regions in a matrix in plan view.

Corresponding to each subpixel region, a pixel electrode 9 and a thin film transistor (TFT) 30 for performing switching control of the pixel electrode 9 are provided.

Also formed in the image display region 10a are a plurality of data lines 6a and scanning lines 3a extending in a grid pattern.

The TFT 30 has its source connected to the data line 6a and its gate connected to the scanning line 3a.

The drain of the TFT 30 is connected to the pixel electrode 9.

The data line 6a is connected to the data-line drive circuit 101 to supply image signals S1, S2, . . . , Sn supplied from the data-line drive circuit 101 to each subpixel region.

The scanning line 3a is connected to the scanning-line drive circuit 104 to supply scanning signals G1, G2, . . . , Gm supplied from the scanning-line drive circuit 104 to each subpixel region.

The image signals S1 to Sn supplied from the data-line drive circuit 101 may be supplied in this order to the data lines 6a in a line sequential manner, or may be supplied to a group of a plurality of data lines 6a adjacent to one another, group by group.

The scanning-line drive circuit 104 supplies the scanning signals G1 to Gm as pulses at a predetermined timing to the scanning lines 3a in a line sequential manner.

The liquid crystal device 100 is configured such that the TFT 30 serving as a switching element is turned on for a certain period by inputting of the scanning signals G1 to Gm, so that the image signals S1 to Sn supplied from the data line 6a are written to the pixel electrode 9 at a predetermined timing.

Then, the image signals S1 to Sn at a predetermined level that have been written through the pixel electrode 9 to the liquid crystal are retained for a certain period between the pixel electrode 9 and a common electrode to be described later that is disposed facing the pixel electrode 9 with the liquid crystal layer 50 interposed therebetween.

Here, in order to prevent the retained image signals S1 to Sn from leaking, a storage capacitor 17 is connected in parallel to a liquid crystal capacitor formed between the pixel electrode 9 and the common electrode.

The storage capacitor 17 is provided between the drain of the TFT 30 and a capacitor line 3b.

Next, the detailed configuration of the liquid crystal device 100 is described with reference to FIGS. 3 and 4.

In FIG. 3, the short axis direction of a substantially rectangular subpixel region in plan view, the short axis direction of pixel electrode 9, and the extending directions of the scanning line 3a and the capacitor line 3b are defined as the X-axis direction, and the long axis direction of the subpixel region, the long axis direction of the pixel electrode 9, and the extending direction of the data line 6a are defined as the Y-axis direction.

The liquid crystal device 100 includes, as shown in FIG. 4, the element substrate 10 and the counter substrate 20 facing each other with the liquid crystal layer 50 sandwiched therebetween, a phase difference plate 33 and a polarizing plate 36 disposed on the outside (the opposite side to the liquid crystal layer 50) of the element substrate 10, a phase difference plate 34 and a polarizing plate 37 disposed on the outside (the opposite side to the liquid crystal layer 50) of the counter substrate 20, and a lighting system 60 disposed on the outside of the polarizing plate 36 for applying illumination light from the outside of the element substrate 10.

As shown in FIG. 3, the pixel electrode 9 being substantially rectangular in plan view is formed in each subpixel region.

The data lines 6a extend along the long side edges among peripheral edges of the pixel electrode 9, and the scanning lines 3a extend along the short side edges.

Formed on the side of the pixel electrode 9 of the scanning line 3a is the capacitor line 3b extending in parallel to the scanning line 3a.

Here, as shown in FIG. 1B, formed on the counter substrate 20 is the light-shielding film (black matrix) 23 to frame a formation region of the pixel electrode 9 in plan view.

The light-shielding film 23 extends in the X-axis direction and the Y-axis direction to be formed in a grid pattern.

Formed on the scanning line 3a is the TFT 30 serving as a switching element.

The TFT 30 includes a semiconductor layer 35 made of an island-shaped amorphous silicon film, and a source electrode 6b and a drain electrode 32 that are disposed partially overlapping the semiconductor layer 35 in plan view.

At a position of the scanning line 3a where the scanning line 3a overlaps the semiconductor layer 35 in the plan view, the scanning line 3a functions as the gate electrode of the TFT 30.

The source electrode 6b has an end opposite to the semiconductor layer 35, the end being connected to the data line 6a.

The drain electrode 32 has an end opposite to the semiconductor layer 35, the end constituting a capacitor electrode 31.

The capacitor electrode 31 is disposed in a planar area of the capacitor line 3b, and formed at the position concerned is the storage capacitor 17 with the capacitor electrode 31 and the capacitor line 3b serving as the electrodes.

Through a pixel contact hole 14 formed in a planar area of the capacitor electrode 31, the pixel electrode 9 and the capacitor electrode 31 are electrically connected, establishing electrical connection between the drain of the TFT 30 and the pixel electrode 9.

In the embodiment, a rectangular region indicated by an alternate long and two short dashes line at a corner of each subpixel region constitutes a spacer arrangement region SA in which spacers to be described later are arranged.

The spacer arrangement region SA is included in a light shielding area shielded from light by the data line 6a, the scanning line 3a, the capacitor line 3b, the light-shielding film 23 or the like.

As shown in FIG. 4, the element substrate 10 has, as its base, a substrate body 11 made of a translucent material such as glass, quartz or plastic.

Formed on the inner side (side of the liquid crystal layer 50) of the substrate body 11 are the scanning line 3a and the capacitor line 3b, a gate insulating film 12 that covers the scanning line 3a and the capacitor line 3b, the semiconductor layer 35 that faces the scanning line 3a with the gate insulating film 12 interposed therebetween, the source electrode 6b (data line 6a) that is connected to the semiconductor layer 35, the drain electrode 32, and the capacitor electrode 31 that is connected to the drain electrode 32 and that faces the capacitor line 3b with the gate insulating film 12 interposed therebetween.

That is, the TFT 30 and the storage capacitor 17 connected thereto are formed on the substrate body 11.

A planarization film 13 for planarization of unevenness on the substrate caused by the TFT 30 and other portions is formed, covering the TFT 30.

The pixel contact hole 14 that passes through the planarization film 13 and reaches the capacitor electrode 31 is formed, and the pixel electrode 9 formed on the planarization film 13 is electrically connected to the capacitor electrode 31 through the pixel contact hole 14.

An orientation film 18 is formed, covering the pixel electrode 9.

The orientation film 18 is made, e.g., of polyimide, and its surface has been subjected to rubbing treatment.

The counter substrate 20 is made of a translucent material such as glass, quartz or plastic, and has a substrate body 21 as its base.

Formed on the inner side (side of the liquid crystal layer 50) of the substrate body 21 are a color filter 22 composed of coloring material layers of color types each corresponding to each subpixel region, a common electrode 25 and an orientation film 29, which are stacked one over another.

The common electrode 25 is made of a transparent conductive material such as indium tin oxide (ITO), and has a planar shape covering a plurality of subpixel regions.

A planarization film for planarization of unevenness on the color filter 22 may be formed between the common electrode 25 and the color filter 22.

The orientation film 29 is made, e.g., of polyimide, and is formed, covering the common electrode 25.

The surface of the orientation film 29 has been subjected to rubbing treatment.

The polarizing plates 36 and 37 are disposed such that their transmission axes are substantially perpendicular to each other.

The phase difference plate 33 provided on the inner side of the polarizing plate 36 and the phase difference plate 34 provided on the inner side of the polarizing plate 37 are λ/4 phase difference plates to provide a phase difference of a substantially quarter wavelength to transmitted light, and may be ones composed of a λ/4 phase difference plate and a λ/2 phase difference plate stacked over each other.

In the liquid crystal device 100 of the embodiment, as shown in FIGS. 3 and 4, a plurality of particulate spacers 41 for regulating a gap between the element substrate 10 and the counter substrate 20 are arranged in the spacer arrangement region SA between the element substrate 10 and the counter substrate 20.

The spacer 41 is made, e.g., of a resin material, and has a spherical shape with a diameter equal to the length of the gap between the element substrate 10 and the counter substrate 20.

### Method for Manufacturing Liquid Crystal Device

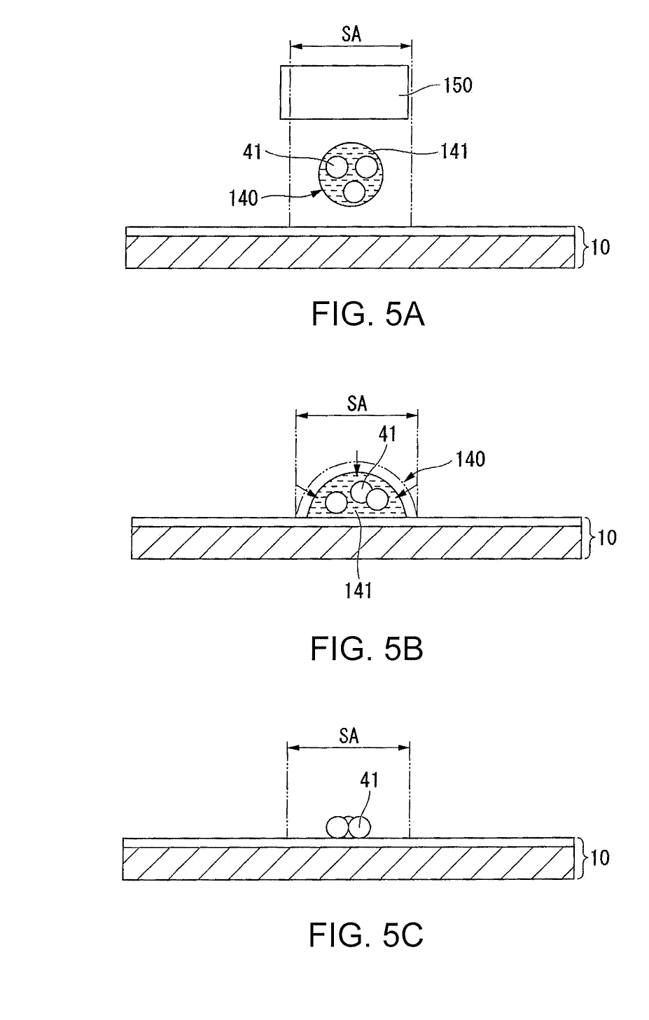

Next, a method for manufacturing the liquid crystal device 100 of the embodiment is described with reference to FIGS. 5A to 5C, 6 and 7A to 7C.

The spacer arrangement step, the liquid crystal application step and the substrate bonding step are mainly described below, and the other steps are appropriately omitted.

Note that known processes may be employed for the other steps.

As shown in FIG. 5A, the element substrate 10 in which the TFT 30, the pixel electrode 9 and the orientation film 18 are formed is prepared.

Then, a droplet discharge head 150 of a droplet discharge device is disposed at a predetermined position on the element substrate 10, and discharges a droplet 140 from the droplet discharge head 150 to the spacer arrangement region SA.

As a result, as shown in FIG. 5B, the droplet 140 is placed in the spacer arrangement region SA.

The droplet 140 is provided by discharging a small amount of a liquid substance containing the spacers 41 dispersed in a dispersion medium 141 from the droplet discharge head 150.

As the dispersion medium 141, a liquid such as water and alcohol having volatility can be used.

Next, the droplet 140 placed on the element substrate 10 is naturally dried, vacuum dried or heat dried to remove the dispersion medium 141 in the droplet 140.

At this point, since the dispersion medium 141 evaporates from the surface of the droplet 140 where the droplet 140 is in contact with the atmosphere, the spacers 41 dispersed in the droplet 140 collect together at one place in the process of drying the droplet 140.

When the dispersion medium 141 has been completely removed, the spacers 41 are arranged in the spacer arrangement region SA on the element substrate 10, as shown in FIGS. 5A to 5C (the spacer arrangement step).

Next, the sealing material 52 is applied in advance around the image display region 10a on the element substrate 10, and liquid crystal is discharged and applied as droplets to the image display region 10a.

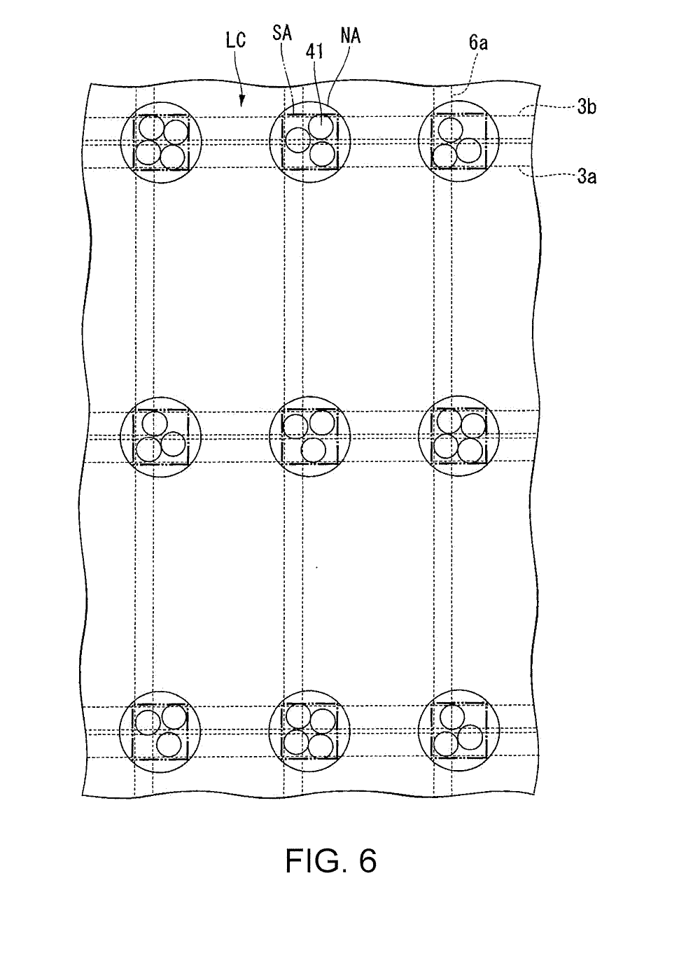

At this point, as shown in FIG. 6, liquid crystal LC is applied so as to enclose the spacer arrangement region SA in which the spacers 41 are arranged, thereby forming a liquid crystal non-application region NA to which the liquid crystal LC is not to be applied (the liquid crystal application step).

Here, when droplets of the liquid crystal LC are discharged, the droplets are arranged uniformly around the spacer arrangement region SA without creating a clearance to form the liquid crystal non-application region NA, which has a shape such as a circle in plan view.

This arrangement causes the spacer arrangement region SA to be included in the liquid crystal non-application region NA in which the liquid crystal LC is not to be applied.

When the liquid crystal LC is discharged and applied as droplets onto the element substrate 10, the droplets are thus prevented from being in contact with the spacers 41, enabling the spacers 41 to be prevented from moving to the outside of the spacer arrangement region SA.

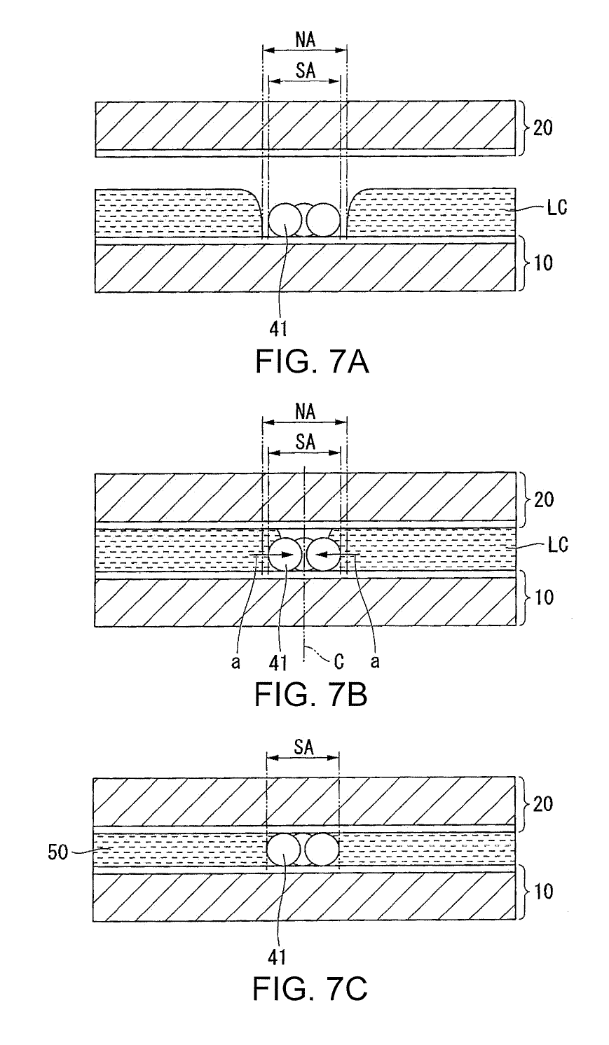

As shown in FIG. 7A, the counter substrate 20 is disposed facing the element substrate 10.

Subsequently, as shown in FIG. 7B, the element substrate 10 and the counter substrate 20 are bonded together with the sealing material 52 interposed therebetween (the substrate bonding step).

At this point, the liquid crystal LC flows between the element substrate 10 and the counter substrate 20 due to the pressure upon bonding.

Here, in the embodiment, forming the liquid crystal non-application region NA by applying the liquid crystal LC to enclose the spacer arrangement region SA as described above causes the liquid crystal LC upon flowing to flow from the periphery of the liquid crystal non-application region NA toward the inside, and further flow from the periphery of the spacer arrangement region SA toward the inside, as indicated by an arrow a of FIG. 7B.

Accordingly, although the spacers 41 arranged in the spacer arrangement region SA may move in the direction from the periphery toward the inside of the spacer arrangement region SA by the flow of the liquid crystal LC, they can be prevented from moving from the inside to the outside of the spacer arrangement region SA.

Placing droplets of the liquid crystal LC uniformly around the spacer arrangement region SA causes the liquid crystal LC to uniformly flow from the periphery of the spacer arrangement region SA toward a center portion C.

As a result, the spacers 41 are gathered around the center portion C of the spacer arrangement region SA.

This enables the spacers 41 to be prevented with more reliability from moving to the outside of the spacer arrangement region SA.

Applying the liquid crystal LC to the element substrate 10 having spacers 41 arranged thereon allows arrangement of the spacers 41 and application of the liquid crystal LC to be performed collectively on the element substrate 10.

This enables the manufacturing device to be simplified.

When the counter substrate 20 is bonded to the element substrate 10, precise alignment of the spacers 41 arranged on the element substrate 10 with the counter substrate 20 is not needed if the counter substrate 20 is aligned with the element substrate 10.

This facilitates alignment of the counter substrate 20, enabling the manufacturing steps to be simplified.

As described above, according to the method for manufacturing the liquid crystal device 100 of the embodiment, the spacers 41 can be prevented from moving out of the spacer arrangement region SA by the flow of the liquid crystal LC.

Therefore, in the liquid crystal device 100, defective display due to movement of the spacers 41 can be prevented and the cell gaps can be made uniform, resulting in improved display quality of the liquid crystal device 100.

### Second Embodiment

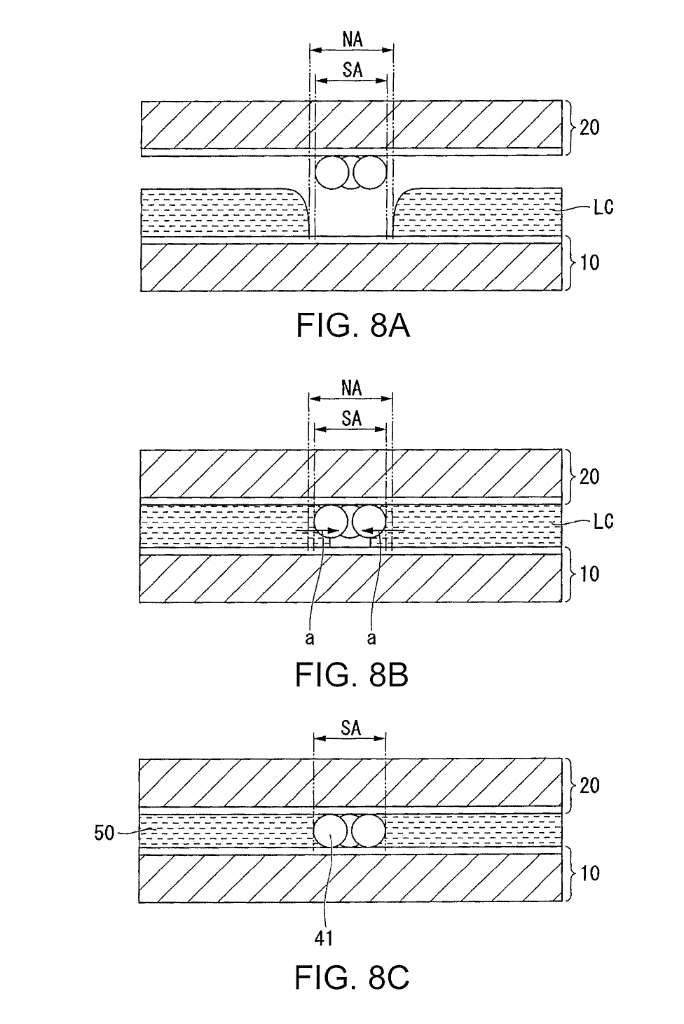

The second embodiment of the invention is next described with reference to FIGS. 8A to 8C as well as FIGS. 1A to 6.

The manufacturing method of the liquid crystal device 100 of the present embodiment differs from the manufacturing method described in the above first embodiment in arranging the spacers 41 on the counter substrate 20 in the spacer arrangement step.

Other respects of the embodiment are the same as those of the first embodiment, and therefore the same parts as those in the first embodiment are designated by the same reference numerals and the same description is not repeated.

First, instead of the element substrate 10 shown in FIG. 5A, the counter substrate 20 is prepared.

Then, the droplets 140 are discharged from the droplet discharge head 150 disposed at a predetermined position on the counter substrate 20 to the spacer arrangement region SA on the counter substrate 20.

At this point, droplets in which an adhesive for adhering the spacers 41 to the counter substrate 20 is added to a dispersion medium for dispersing the spacers 41 are used.

In the same way as in the first embodiment shown in FIG. 5B, the droplets 140 are arranged in the spacer arrangement region SA of the counter substrate 20, and the dispersion medium 141 is removed.

When the dispersion medium 141 has completely been removed, the spacers 41 are arranged in the spacer arrangement region SA on the counter substrate 20, as shown in FIG. 5C (the spacer arrangement step).

At this point, the spacers 41 are fixed onto the counter substrate 20 by the adhesive added to the dispersion medium.

In parallel to the spacer arrangement step, liquid crystal is discharged and applied as droplets in an area corresponding to the image display region 10a on the element substrate 10.

At this point, in the same way as in the first embodiment shown in FIG. 6, the liquid crystal LC is applied so as to enclose the spacer arrangement region SA in which spacers 41 are to be arranged, thereby forming the liquid crystal non-application region NA to which the liquid crystal LC is not to be applied (the liquid crystal application step).

Next, as shown in FIG. 8A, the counter substrate 20 is placed facing the element substrate 10.

Subsequently, as shown in FIG. 8B, the element substrate 10 and the counter substrate 20 are bonded together with the sealing material 52 interposed therebetween (the substrate bonding step).

At this point, the liquid crystal LC flows between the element substrate 10 and the counter substrate 20 due to the pressure upon bonding.

Here, in the embodiment, the spacers 41 are arranged in the spacer arrangement region SA of the counter substrate 20 and the liquid crystal non-application region NA is formed by application of the liquid crystal LC to enclose the spacer arrangement region SA, as described above.

Just as in the first embodiment, this causes the liquid crystal LC upon flowing to flow from the periphery of the liquid crystal non-application region NA toward the inside, and further flow from the periphery of the spacer arrangement region SA toward the inside, as indicated by an arrow a of FIG. 8B.

Therefore, although the spacers 41 arranged in the spacer arrangement region SA may move in the direction from the periphery toward the inside of the spacer arrangement region SA by the flow of the liquid crystal LC, they can be prevented from moving from the inside to the outside of the spacer arrangement region SA.

Thus, as shown in FIG. 8C, the spacers 41 are arranged in the predetermined spacer arrangement region SA.

As described above, the method for manufacturing the liquid crystal device 100 of the embodiment enables not only the same effects as in the first embodiment to be obtained but also the spacer arrangement step as well as the liquid crystal application step to be performed in parallel to each other at one time.

Therefore, the productivity of the liquid crystal device 100 can be improved.

### Third Embodiment

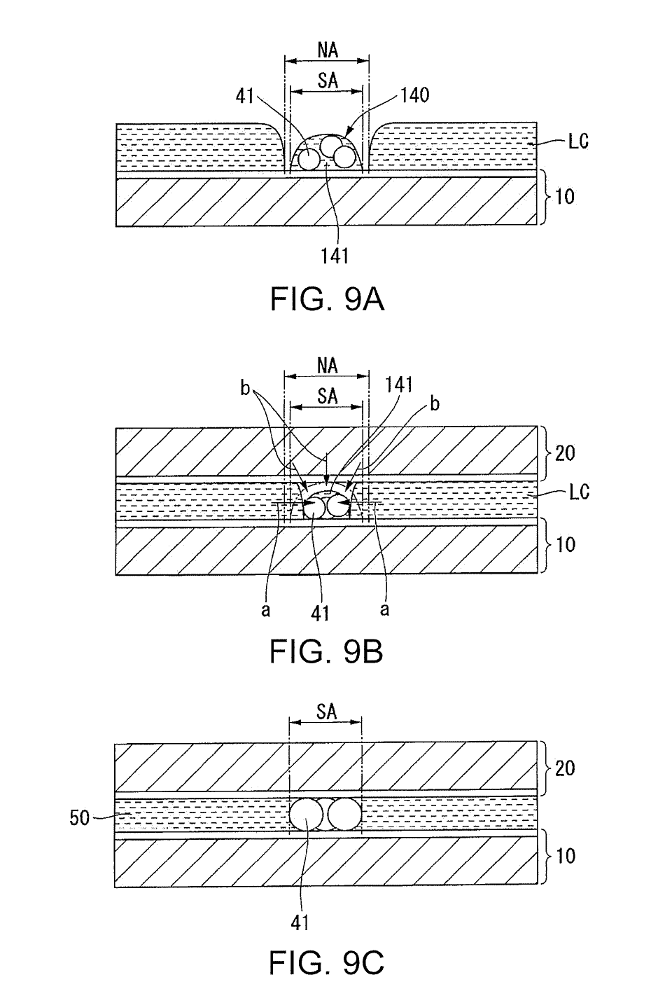

The third embodiment of the invention is next described with reference to FIGS. 9A to 9C as well as FIGS. 1A to 6.

The manufacturing method of the liquid crystal device 100 of the present embodiment differs from the manufacturing method described in the above first embodiment in arranging the spacers 41 after applying the liquid crystal LC onto the element substrate 10.

Other respects of the embodiment are the same as those of the first embodiment, and therefore the same parts as those in the first embodiment are designated by the same reference numerals and the same description is not repeated.

First, as shown in FIG. 9A, the sealing material 52 is applied in advance around the image display region 10a on the element substrate 10, and liquid crystal is discharged and applied as droplets to the image display region 10a, as in the first embodiment.

At this point, as shown in FIG. 6, the liquid crystal LC is applied so as to enclose the spacer arrangement region SA on the element substrate 10, thereby forming the liquid crystal non-application region NA to which the liquid crystal LC is not to be applied (the liquid crystal application step).

Next, as in the first embodiment, the droplets 140 are discharged from the droplet discharge head 150 to the spacer arrangement region SA, thereby arranging the droplets 140 in the spacer arrangement region SA.

In the embodiment, the counter substrate 20 is bonded to the element substrate 10 at the same time that the droplets 140 are vacuum dried or heat dried to remove the dispersion medium 141 in the droplet 140.

As a result, during a process in which the droplets 140 dry, the spacers 41 dispersed in the droplets 140 collect at one place as indicated by an arrow b while liquid crystal flows from the periphery of the liquid crystal non-application region NA toward the inside, and further flows from the periphery of the spacer arrangement region SA toward the inside, as indicated by the arrow a of FIG. 8B.

When the dispersion medium 141 has completely been removed, the spacers 41 are arranged in the spacer arrangement region SA on the element substrate 10, and the element substrate 10 and the counter substrate 20 are bonded together with each other as shown in FIG. 9C (the spacer arrangement step and the substrate bonding step).

Therefore, the method for manufacturing the liquid crystal device 100 of the embodiment enables not only the same effects as in the first embodiment to be obtained but also the spacer arrangement step as well as the substrate bonding step to be performed collectively, enabling the productivity of the liquid crystal device 100 to be improved.

Also, as described above, the droplets 140 discharged to the liquid crystal non-application region NA are dried to evaporate the dispersion medium 141 and the liquid crystal LC is caused to flow into the liquid crystal non-application region NA.

This allows the liquid crystal LC to flow into the spacer arrangement region SA as the dispersion medium 141 evaporates.

Therefore, the spacers 41 can be prevented with more reliability from moving to the outside of the spacer arrangement region SA.

Also, in the case where the liquid crystal LC is used as the dispersion medium 141, the dispersion medium 141 need not be dried for removal.

Therefore, a step of drying the dispersion medium 141 for removal can be omitted, simplifying the manufacturing steps of the liquid crystal device 100.

This enables the productivity of the liquid crystal device 100 to be improved.

It should be noted that this invention is not limited to the foregoing embodiments, and various changes and modifications can be made without departing from the spirit of the invention.

For example, although liquid crystal is applied with spacers arranged on the element substrate in the foregoing first and third embodiments, liquid crystal may be applied with spacers arranged on the counter substrate in place of the element substrate.

In the second embodiment, liquid crystal may be applied onto the counter substrate with spacers arranged on the element substrate.

In the case where a spacer arrangement region is the liquid crystal non-application region NA, liquid crystal enclosing the spacer arrangement region prevents a liquid substance applied to the spacer arrangement region from moving to the outside of the spacer arrangement region.

Therefore, spacer particles are prevented from moving from the inside to the outside of the spacer arrangement region.

A dispersing agent may be added in order to prevent spacers from aggregating in a dispersion medium in which the spacers are to disperse.

A droplet discharge device having a droplet discharge head is not specifically limited if it can discharge and arrange a liquid substance with spacers dispersed therein at a predetermined position.

The entire disclosure of Japanese Patent Application No. 2007-312067, filed Dec. 3, 2007 is expressly incorporated by reference herein.

What is claimed is:

1. A method for manufacturing a liquid crystal device having liquid crystal sandwiched between a pair of substrates that are bonded together with a sealing material interposed therebetween, the method comprising:
(a) arranging a spacer particle for regulating a gap between the pair of substrates in a spacer arrangement region of one of the pair of substrates;
(b) applying, when discharging and applying the liquid crystal as a droplet to an image display region of one of the pair of substrates, the liquid crystal to enclose the spacer arrangement region, thereby forming a liquid crystal non-application region that includes the spacer arrangement region and to which the liquid crystal is not applied; and
(c) causing the pair of substrates to face each other and bonding the pair of substrates together with a sealing material interposed therebetween.

2. The method for manufacturing a liquid crystal device according to claim 1, wherein, in step (b), the droplet is applied uniformly around the spacer arrangement region.

3. The method for manufacturing a liquid crystal device according to claim 1, wherein:
in step (a), the spacer particle is arranged on one of the pair of substrates; and
in step (b), the liquid crystal is applied onto the other of the pair of substrates.

4. The method for manufacturing a liquid crystal device according to claim 1, wherein:
in step (a), the spacer particle is arranged on one of the pair of substrates; and
in step (b), the liquid crystal is applied onto the substrate on which the spacer particle is arranged.

5. The method for manufacturing a liquid crystal device according to claim 4, wherein the liquid crystal is applied in step (b), and thereafter a liquid substance containing the spacer particle dispersed therein is discharged and applied as a droplet to the spacer arrangement region.

6. The method for manufacturing a liquid crystal device according to claim 5, wherein the liquid substance is the liquid crystal.

7. The method for manufacturing a liquid crystal device according to claim 5, wherein the liquid substance has volatility that volatilize the liquid substance applied to the liquid crystal non-application region in step (a) and that causes the liquid crystal to flow into the liquid crystal non-application region.
